(19) United States
(12) Patent Application Publication
(10) Pub. No.: US 2014/0093971 A1
(43) Pub. Date: Apr. 3, 2014

(54) System and Method for Determining Concentration of Oxygen in Chemical Mixtures

(71) Applicant: GENERAL ELECTRIC COMPANY, Schenectady, NY (US)

(72) Inventor: Daniel George Norton, Niskayuna, NY (US)

(73) Assignee: GENERAL ELECTRIC COMPANY, Schenectady, NY (US)

(21) Appl. No.: 13/629,639

(22) Filed: Sep. 28, 2012

(51) Int. Cl. G06F 19/00; G01N 25/22; G01N 27/62

(52) U.S. Cl. 436/136; 702/24; 422/83; 422/98

(57) ABSTRACT

A system for determining concentration of oxygen in a chemical mixture is presented. The system includes a first sensing device configured to measure the concentration of oxygen in the chemical mixture and generate a first output signal, where the first output signal is indicative if the concentration of oxygen in the chemical mixture and a type of the chemical mixture. Furthermore, the system includes a second sensing device configured to measure the concentration of oxygen in the chemical mixture and generate a second output signal. In addition, the system includes a processing unit operatively coupled to the first sensing device and the second sensing device and configured to determine the concentration of oxygen in the chemical mixture based on the first output signal, the second output signal, or both the first output signal and the second output signal based on a type of the chemical mixture.

### BACKGROUND

Embodiments of the present disclosure are related to chemical mixtures, and more particularly to determining the concentration of oxygen in chemical mixtures.

A reducing environment or mixture, also known as a reduction atmosphere, is an atmospheric condition in which oxidation is prevented by removal of oxygen and other oxidizing gases or vapors. These mixtures may include significant concentration of reductants (or reducing agents) such as hydrocarbons, hydrogen, carbon monoxide, or any other gases, such as hydrogen sulfide, that may oxidize in the presence of oxygen. The oxygen-starved reducing mixtures may be utilized in various industrial processes such as gasification, annealing, firing ceramic wares, or commercial incineration.

Occasionally, the concentration of oxygen in such mixtures may increase due to errors in the manufacturing process, leaks in the delivery mechanism, or other such operator or system errors. The increased oxygen level, if left unchecked, may induce spontaneous combustion, cause a reduction-oxidation (redox) reaction, affect efficiency of the processes, and so on. It may therefore be desirable to periodically monitor the concentration of oxygen in the reducing mixtures.

Oxygen sensors have been typically employed to detect oxygen levels in the exhaust of automobiles. These currently available oxygen sensors, however, may be unsuitable to monitor the concentration of oxygen in reducing environments. One such sensor, a lambda sensor, often termed as an “oxygen sensor” is typically utilized in gasoline automobiles to determine whether exhaust gases are lean or rich in nature. Lean mixtures are representative of mixtures that have excessive oxygen content and rich mixtures are generally representative of mixtures that have relatively low levels of oxygen. To detect the nature of the exhaust gas, the lambda sensor typically includes a ceramic (zirconia) cylinder surrounded by porous platinum electrodes on the inside and the outside of the cylinder. One electrode of the lambda sensor is disposed in the exhaust gas, while the other electrode of the lambda sensor is disposed in reference air. As the oxygen content in the exhaust gas and the reference air varies, a flux is induced between the two electrodes and oxygen may permeate from one side of the ceramic cylinder to the other. This flux across the electrodes increases a voltage across the electrodes. By measuring this voltage, the lambda sensor determines whether the exhaust gas is lean or rich. A high voltage indicates a rich mixture, while a low voltage indicates a lean mixture.

Although lambda sensors operate in a satisfactory manner for automobiles where the oxygen levels are comparatively high, these lambda sensors may suffer from several limitations in reducing environments. For example, in a reducing mixture, where reductant levels are high the lambda sensor may erroneously record a very high voltage (indicative of very low oxygen levels) in the presence of moderate oxygen levels. This anomaly occurs because lambda sensors are inherently less sensitive in very rich or very lean environments, where this probe may not be able to accurately determine the oxygen levels. Moreover, reductants such as hydrocarbons, hydrogen, or carbon monoxide present in the reducing mixture may react with the residual oxygen on the platinum electrode. Such a reaction may consume the oxygen in the mixture, thereby increasing the flux across the zirconia cylinder of the lambda sensor and consequently the voltage measured. Therefore, the detected voltage may erroneously indicate zero oxygen levels, where, in fact, non-zero oxygen levels may be present. Moreover, for a given concentration of oxygen in different concentrations of reductants, the lambda sensor may generate different voltages. Accordingly, the lambda sensor may fail to accurately measure the concentration of oxygen in reducing mixtures.

### BRIEF DESCRIPTION

In accordance with aspects of the present disclosure, a system for determining concentration of oxygen in a chemical mixture is presented. The system includes a first sensing device configured to measure the concentration of oxygen in the chemical mixture and generate a first output signal. Further, the system includes a second sensing device configured to measure the concentration of oxygen in the chemical mixture and generate a second output signal. Moreover, the system includes a processing unit operatively coupled to the first sensing device and the second sensing device and configured to determine the concentration of oxygen in the chemical mixture based on the first output signal, the second output signal, or both the first output signal and the second output signal based on a type of the chemical mixture.

In accordance with another aspect of the present disclosure, a method for determining concentration of oxygen in a chemical mixture is presented. The method includes measuring the concentration of oxygen in the chemical mixture using a first sensing device. Further, the method includes generating a first output signal based on the measurement by the first sensing device, where the first output signal is indicative of the concentration of oxygen in the mixture and a type of the chemical mixture. In addition, the method includes measuring the concentration of oxygen in the chemical mixture using a second sensing device. Subsequently, the method generates a second output signal based on the measurement by the second sensing device. The method proceeds to determine the concentration of oxygen in the chemical mixture using the first output signal, the second output signal, or both the first output signal and the second output signal based on the type of the mixture.

In accordance with yet another embodiment of the present disclosure, a system for determining concentration of oxygen in a reducing mixture is presented. The system includes a combined oxygen sensor that includes a lambda sensor configured to measure the concentration of oxygen in the reducing mixture and generate a first output signal indicative of a type of the reducing mixture, where the type of the reducing mixture includes a rich mixture or a lean mixture. The combined oxygen sensor further includes a lower explosion limit sensor configured to measure the concentration of oxygen in the reducing mixture and generate a second output signal, where the second output signal is indicative of the concentration of oxygen in the rich mixture and indicative of the concentration of reductants in the lean mixture. Moreover, the combined oxygen sensor includes a processing unit coupled to the lambda sensor and the lower explosion limit sensor and configured to utilize the first output signal if the mixture is the lean mixture and the second output signal if the mixture is the rich mixture.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical illustration of an exemplary chemical processing plant, according to aspects of the present disclosure;

FIG. 2 is a diagrammatical representation of an exemplary combined oxygen sensor, according to aspects of the present disclosure;

FIG. 3 is a diagrammatical representation of a lambda sensor for use in the exemplary combined oxygen sensor of FIG. 2, according to aspects of the present disclosure;

FIG. 4 is a diagrammatical representation of a lower explosion limit sensor for use in the exemplary combined oxygen sensor of FIG. 2, according to aspects of the present disclosure; and

FIG. 5 is a flowchart illustrating an exemplary method for determining the concentration of oxygen in a mixture, according to aspects of the present disclosure.

### DETAILED DESCRIPTION

Embodiments of the present disclosure are related to detecting the concentration of oxygen in reducing mixtures. To this end, embodiments of the present disclosure include a combined oxygen sensor. The combined oxygen sensor may be configured to determine the concentration of oxygen in chemical mixtures and preferably in reducing chemical mixtures. Moreover, the combined oxygen sensor enhances the efficacy of measuring the concentration of oxygen.

Throughout this disclosure, the terms “reducing mixture” and “reducing environment” may be interchangeably used. The term reducing mixture refers to a mixture that has a high concentration of reductants (or reducing agents) and zero or very low concentration of oxygen. In such mixtures, the concentration of oxygen is typically in a range of about 100 ppm to about 10000 ppm. Moreover, the term “rich mixture” refers to mixtures that have reductants and oxygen, and where the concentration of reductants is higher than that can be oxidized completely by the oxygen in the mixture. Also, the term “lean mixture” refers to mixtures that have reductants and oxygen, where the concentration of reductants is less than that can be oxidized completely by the oxygen in the mixture.

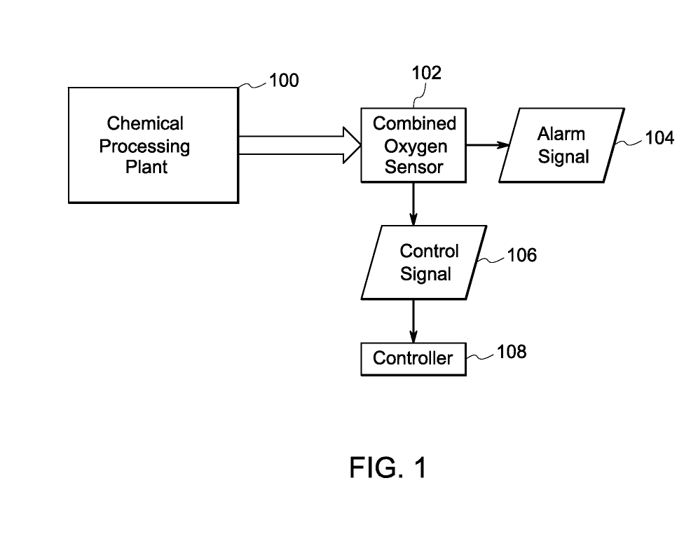

FIG. 1 is a diagrammatical representation of a chemical processing plant 100 that utilizes an exemplary combined oxygen sensor 102, according to aspects of the present disclosure. The chemical processing plant 100 may produce a reducing mixture, such as a flammable gas or liquid. For example, the chemical processing plant 100 may produce synthetic gas or “syngas” that is a mixture of reductants such as carbon monoxide and hydrogen. In the example of FIG. 1, the chemical processing plant 100 is a syngas generating plant. However, it will be understood that in other embodiments of the present disclosure, the combined oxygen sensor 102 may be utilized in any other chemical processing plant that produces reducing mixtures. For instance, the combined oxygen sensor 102 may be utilized in a plant that produces pure carbon monoxide, hydrogen, or any other hydrocarbon.

Moreover, the combined oxygen sensor 102 may also be utilized in any other plant that utilizes reducing mixtures or produces reducing mixtures as a byproduct. For instance, the combined oxygen sensor 102 may be coupled to a reducing mixture inlet pipe in a gas turbine plant or to an exhaust of the gas turbine plant, without departing from the scope of the present disclosure. Alternatively, the combined oxygen sensor 102 may be utilized, by way of example, in an annealing process, in systems for firing ceramic wares or in commercial incinerators. In addition, the combined oxygen sensor 102 may be utilized as an on-board diagnostics monitor in automobiles, without departing from the scope of the present disclosure.

In the presently illustrated embodiment of FIG. 1, the chemical processing plant 100 utilizes coal and/or petro coke as raw material to produce syngas as an output. Moreover, the syngas may be produced by pulverizing the raw material and heating the pulverized raw material in the presence of oxygen, in a process commonly referred to as gasification. Subsequently, the syngas may be cooled in a process where the syngas releases high pressure steam. The produced syngas may then be stored or actively utilized in a gas turbine to generate power, for example.

As described previously, syngas is generally a mixture of carbon monoxide and hydrogen, which are commonly known reductants. Therefore, syngas is a reducing mixture. Furthermore, syngas is flammable. During gasification or the subsequent cooling process, trace levels of residual oxygen may remain in the syngas mixture. Hence, if a catalytic material or heat is introduced to this flammable mixture having residual oxygen, the mixture may combust. Accordingly, it may be desirable to ensure that the mixture does not have any oxygen content or that the levels of oxygen within the mixture remain very low (typically lesser than 1000 ppm). However, during production of syngas, some errors may creep into the process that may result in a higher concentration of residual oxygen in the syngas mixture. Furthermore, in other applications, even if the reducing mixture is a non-flammable mixture, if oxygen is introduced into the mixture, a redox reaction may occur. This redox reaction may alter the reducing mixture. It is therefore desirable to monitor and/or determine the concentration of oxygen in such mixtures. Moreover, the concentration of oxygen may be monitored continuously or at determined intervals of time. To that end, the exemplary combined oxygen sensor 102 may be employed to determine the concentration of oxygen in the reducing mixture, such as syngas.

In one embodiment, the combined oxygen sensor 102 may be configured to generate an alarm signal 104 that is indicative of the fact that the concentration of oxygen in the reducing mixture has crossed a determined threshold concentration value. Additionally, the combined oxygen sensor 102 may be configured to generate a control signal 106. This control signal 106 may aid in controlling the production process to lower the concentration of oxygen in the mixture. Furthermore, the combined oxygen sensor 102 may be configured to communicate the control signal 106 to a controller 108. In one embodiment, the controller 108 may be configured to alter the process parameters based on the control signal. More particularly, the process parameters may be altered such that the oxygen concentration in the mixture is lowered to a value below the determined threshold value.

As described previously, conventional oxygen sensors, such as lambda sensors suffer from several limitations when used to measure the concentration of oxygen in mixtures. For instance, while these conventional sensors are capable of estimating the concentration of oxygen in rich or lean mixtures, these sensors fail to accurately determine the concentration of oxygen in the mixtures. The lambda sensor, for example, measures the ratio of fuel to air in exhaust gases of automobiles, instead of the concentration of oxygen in the exhaust gases. Using approximations for engine performance with a given fuel to air ratio, the concentration of oxygen may be estimated from the measured ratio of fuel to air. Though an estimate of the concentration of oxygen may be sufficient in certain applications, this estimation is insufficient in applications that utilize reducing mixtures. For instance, conventional oxygen sensors may fail to differentiate between a mixture with 500 ppm oxygen and a mixture with 1000 ppm oxygen. It may be noted that in reducing mixtures small variations in the oxygen concentration may convert a stable mixture into an unstable mixture. Accordingly, it is desirable to differentiate between reducing mixtures with varied levels of concentration. Embodiments of the present disclosure introduce the combined oxygen sensor 102 that is configured to determine the concentration of oxygen with sufficient accuracy to overcome the shortcomings of conventional oxygen sensors. In the present disclosure, sufficient accuracy or sufficiently accurate may refer to an accuracy in the range of ±10 ppm.

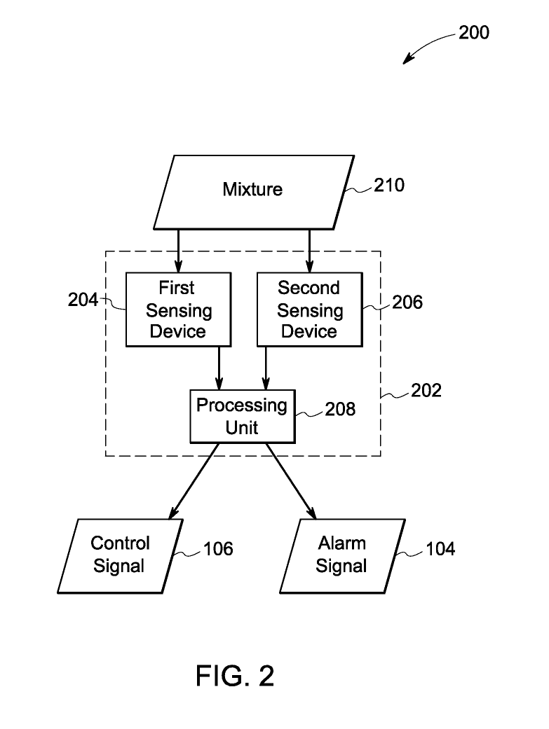

FIG. 2 is a diagrammatical representation of one embodiment 200 of the combined oxygen sensor 102 of FIG. 1. According to some embodiments of the present disclosure, a combined oxygen sensor 202 (which is representative of the combined oxygen sensor 102 of FIG. 1) may include a first sensing device 204, a second sensing device 206, and a processing unit 208. The first sensing device 204 and the second sensing device 206 may be operatively coupled to the processing unit 208 through wired or wireless means such that electrical or data signals may be exchanged between the first and second sensing devices 202, 204 and the processing unit 208. Further, the first sensing device 204 and the second sensing device 206 may be disposed such that the first and second sensing devices 204, 206 are in contact with a mixture 210 to be measured. For instance, these sensing devices 202, 204 may be disposed in the flow of the mixture 210, such as in an inlet pipe, an outlet pipe, or a chamber of the chemical plant 100 (see FIG. 1). Alternatively, a portion of the mixture 210 may be guided to the location of the first and second sensing devices 202, 204 to allow these sensing devices 202, 204 to measure the concentration of oxygen in the mixture 210. Furthermore, the processing unit 208 may be configured to generate an alarm signal, such as the alarm signal 104 (see FIG. 1) or a control signal, such as the control signal 106 (see FIG. 1) based on the concentration of oxygen detected by the sensing devices 202, 204.

The combined oxygen sensor 202, as described previously, is utilized to determine the concentration of oxygen in reducing mixtures. These mixtures are typically very rich and include no oxygen or trace quantities of oxygen. In some instances, however, the mixtures may become lean when excessive concentration of oxygen is erroneously introduced in the mixture. Moreover, the permissible concentration of oxygen in reducing mixtures may be very low. For instance, a threshold value of oxygen may be any value representative of an oxygen concentration between 100 ppm and 200000 ppm of the mixture 210. In accordance with aspects of the present disclosure, for concentration values of oxygen approximately about these threshold values (for example, about 1 ppm to 250000 ppm of the mixture), the combined oxygen sensor 102 may be configured to determine the concentration of oxygen in the mixture with sufficient accuracy. However, for concentration values of oxygen sufficiently above these threshold values (for example, above 250000 ppm of the mixture), the combined oxygen sensor 102 may be configured to estimate the concentration of oxygen in the mixture 210.

Accordingly, the combined oxygen sensor 102 utilizes two sensing devices. The first sensing device 204 may be configured to estimate the concentration of oxygen in the mixture 210 and the second sensing device 206 may be configured to determine the concentration of oxygen in the mixture with sufficient accuracy. More particularly, the first sensing device 204 may be configured to determine whether the mixture 210 is rich or lean. To this end, the first sensing device 204 may produce an electrical or digital output signal that is generally indicative of the type of mixture. The output signal of the first sensing device 204 may also be indicative of an estimated concentration of oxygen in the mixture 210. In one embodiment, the first sensing device 204 may be configured to determine the concentration of oxygen in the mixture 210 by measuring a flux created between the mixture 210 and ambient air because of variation in oxygen levels between the mixture 210 and the ambient air. If the levels of oxygen in the mixture 210 and ambient air are relatively similar, a low flux may be created. Alternatively, if the levels of oxygen in the mixture 210 and the ambient air are dissimilar, a high flux may be created between the mixture 210 and the ambient air.

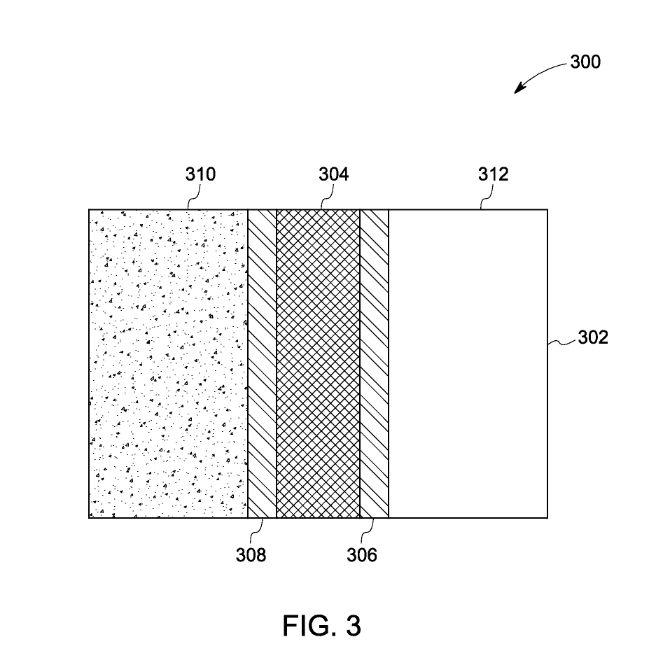

The first sensing device 204 may be configured to convert the measured flux into an electrical voltage signal. Commonly known techniques, such as, but not limited to, connecting a load between the two electrodes may be utilized to convert the measure flux into an electrical voltage signal. For instance, the first sensing device 204 may generate a voltage signal higher than 0.5 V to indicate a rich mixture and a voltage signal lower than 0.5 V to indicate a lean mixture. Further, the voltage signal may be generated such that the voltage signal is also indicative of the concentration of oxygen in the mixture 210. By way of example, a voltage of 0.8 V may be indicative of an approximate concentration of oxygen in the mixture 210. This voltage signal may be transmitted to the processing unit 208. It will be understood that these voltage values are merely exemplary and the first sensing device 204 may be calibrated to generate different voltage readings. Moreover, the output signal generated by the first sensing device 204 may be a current signal, a resistance signal, or a digital signal without departing from the scope of the present disclosure. Working of the first sensing device 204 will be described in detail with reference to FIG. 3.

In one embodiment, the processing unit 208 may be configured to determine whether the output signal from the first sensing device 204 is indicative of a rich mixture or a lean mixture. Accordingly, the processing unit 208 may include a lookup table (not shown), in one example. The lookup table may include oxygen concentration values corresponding to different voltage signal values. By comparing the measured voltage signal output from the first sensing device 204 with the stored voltage signals in the lookup table, the processing unit 208 may be configured to determine the type of mixture and the concentration of oxygen present in the mixture 210. In another embodiment, the processing unit 208 may include a comparator (not shown) that compares the output of the first sensing device 204 with a determined threshold signal. An output voltage lower than the threshold signal may be indicative of a lean mixture and an output voltage higher than the threshold signal may be indicative of a rich mixture or vice-versa.

Moreover, if it is determined that the mixture 210 is lean, the processing unit 208 may be configured to automatically generate the alarm signal 104 and/or the control signal 106 as the concentration of oxygen in the lean mixtures may be sufficiently above the determined threshold value. Alternatively, if it is determined that the mixture 210 is rich, the processing unit 208 may be configured to utilize an output from the second sensing device 206 to determine the concentration of oxygen in the mixture 210.

The second sensing device 206, accordingly, may be configured to measure the concentration of oxygen in rich mixtures. In rich mixtures, the concentration of oxygen is typically lower than that is required to completely oxidize the concentration of reductants. Consequently, any combustion of the reductants occurs until all the oxygen in the mixture 210 is consumed. Accordingly, to facilitate the measurement of the concentration of oxygen in the mixture 210, the second sensing device 206 may be configured to induce combustion in the mixture 210. To this end, the second sensing device 206 may include a catalytic material (not shown). When the rich mixture 210 is brought in contact with the catalytic material, the mixture 210 may combust, if oxygen is present in the mixture 210. Moreover, the combustion may generate heat as an output of an exothermic reaction, and this heat may be proportional to the concentration of oxygen in the rich mixture 210. The greater the concentration of oxygen in the mixture 210, the higher the temperature of the heat generated by the exothermic reaction.

Accordingly, the second sensing device 206 may be configured to measure the concentration of oxygen in the mixture 210 based on the amount of heat generated by the exothermic reaction of the combustion of the mixture 210 and the catalytic material. Further, the second sensing device 206 may generate an output signal corresponding to the amount of generated heat. For instance, the output signal may be a temperature reading, a voltage signal, a resistance value, a current signal and so on without departing from the scope of the present disclosure.

In accordance with further aspects of the present disclosure, in lean mixtures, where the level of oxygen is greater than that is required to oxidize all of the reductants in the mixture 210, the combustion may occur until the reductants are consumed. Once the reductants are completely combusted, the exothermic reaction may stop. However, unburned oxygen may still be present in the lean mixture as oxygen is in surplus in lean mixtures. Accordingly, in lean mixtures, the output signal of the second sensing device 206 may be indicative of the concentration of reductants in the mixture 210.

Further, the processing unit 208 may be configured to utilize the output of the second sensing device 206 to determine the concentration of oxygen in the mixture 210. To that end, the processing unit 208 may include a lookup table corresponding to the output signal from the second sensing device 206. By comparing the output signal from the second sensing device 206 with the stored values for the output signal in the lookup table, the processing unit 208 may be configured to determine the concentration of oxygen in the mixture 210. Moreover, once the processing unit 208 receives the output signal from both the first and second sensing devices 204, 206, the processing unit 208 may determine whether to utilize the output signal from the first sensing device 204 or the output signal from the second sensing device 206. The following sections describe the operation of the processing unit in selecting the output signal from the first sensing device 204 or the second sensing device 206.

In both rich and lean mixtures, the second sensing device 206 may generate one of two outputs—an output value below a determined threshold value or an output value above the determined threshold value. The determined threshold value may be representative of permissible levels of oxygen in the mixture. Accordingly, an output value below the threshold value may be indicative that insignificant combustion has occurred in the second sensing device 206. The deficiency of combustion may be attributed to trace levels of oxygen in the mixture 210 or trace levels of reductants in the mixture 210. It may therefore be desirable to identify the underlying reason for the output value from the second sensing device 206 being below the determined threshold value. To that end, the output signal from the first sensing device 204 may be utilized to differentiate between the two underlying reasons for the output of the second sensing device 206 having a value below the determined threshold value. For example, if the first sensing device 204 identifies the mixture 210 to be a rich mixture, the output of the second sensing device 206 may be indicative that the mixture 210 is a reducing mixture with trace levels of oxygen. However, if the first sensing device 204 determines that the mixture is lean, the output of the second sensing device 206 may be indicative that the mixture 210 has trace levels of reductants.

Moreover, an output value above the determined threshold value may be indicative of a significant combustion event. Again, the significant combustion event may be attributed to the mixture 210 having excessive oxygen in a rich mixture or excessive reductants in a lean mixture. It may therefore be desirable to identify the underlying reason for the output value being above the threshold value. To that end, an output from the first sensing device 204 may be utilized to differentiate between the two underlying reasons for the value of the output of the second sensing device 206 being above the threshold value. For example, if the first sensing device 204 identifies that the mixture 210 is a rich mixture, the output of the second sensing device 206 may be indicative of the concentration of oxygen. Alternatively, if the first sensing device 204 determines that the mixture 210 is a lean mixture, it may be established that the output of the second sensing device 206 is indicative of the concentration of reductants in the mixture 210.

Based on the logic described hereinabove, the processing unit 208 may be configured to utilize the first sensing device 204 or the second sensing device 206 to determine the concentration of oxygen in the mixture 210. In particular, the processing unit 208 may be configured to selectively use the first sensing device 204 or the second sensing device 206 based on the outputs of the first sensing device 204 and the second sensing device 206. Table 1 is a summary of one example of the determination by the processing unit 208 regarding use of the first sensing device 204 or the second sensing device 206. From Table 1, it is evident that the processing unit 208 is configured to utilize the output from the first sensing device 204 if the mixture 210 is lean and the output from the second sensing device 206 if the mixture 210 is rich.

TABLE 1

| | First sensing | Second sensing | Sensor utilized by the |
|---|---|---|---|
| S.N. | device output | device output | processing unit |
| 1 | Lean | Output value below | First sensing device |
| | | the threshold value | |
| 2 | Lean | Output value above | First sensing device |
| | | the threshold value | |
| 3 | Rich | Output value below | Second sensing device |
| | | the threshold value | |
| 4 | Rich | Output value above | Second sensing device |
| | | the threshold value | |

According to one embodiment of the present disclosure, the first sensing device 204 may include a narrow range lambda sensor. The lambda sensor is an air-to-fuel sensor typically employed in gasoline automobiles. In automobiles, the lambda sensor compares the exhaust gases expended by an onboard combustion engine with ambient air to determine whether the exhaust gas is lean or rich. A rich exhaust gas results in the combustion engine releasing harmful gases into the environment. To keep such gases in check, the output of the lambda sensor is provided to an engine control unit (ECU). The ECU is a control system that uses feedback from the lambda sensor to adjust the fuel/air mixture so that the exhaust gases are in a desired proportion of oxygen to reductants to prevent the combustion engine from releasing harmful gases.

FIG. 3 is a diagrammatical representation 300 of an exemplary lambda sensor 302, according to embodiments of the present disclosure. The lambda sensor 302 may be employed as the first sensing device 204 in the combined oxygen sensor 202 of FIG. 2. Further, the lambda sensor 302 may be based on a solid-state electrochemical fuel cell called the Nernst cell, in one embodiment. As illustrated in FIG. 3, the lambda sensor 302 includes a permeable cell membrane 304 and two electrodes 306, 308. The cell membrane 304 along with the two electrodes 306, 308 may be employed to separate a chemical mixture, such as chemical mixture 310 from a reference mixture 312. In some embodiments, the reference mixture 312 may be ambient air. Moreover, the cell membrane 304 and the electrodes 306, 308 may be oxygen permeable, allowing oxygen to flow from one side of the cell membrane 304 to another.

Depending on the concentration of oxygen in the chemical mixture 310 and the reference mixture 312, an oxygen flux is created between the chemical mixture 310 and the reference mixture 312. This flux enables oxygen to permeate from the mixture having higher concentration of oxygen to the mixture having lower concentration of oxygen. Most commonly, this flux direction is from the reference mixture 312 to the chemical mixture 310 as the concentration of oxygen is relatively higher in the reference mixture 312 as compared to that in the chemical mixture 310. Moreover, because of the diffusion of oxygen from the reference mixture 312 to the chemical mixture 310, a potential difference is created across the electrodes 306, 308. The potential difference may be proportional to the flux and therefore may be an indicator of the concentration of oxygen in the chemical mixture 310 as compared to that in the reference mixture 312.

In one embodiment, the cell membrane 304 may be a hollow cylinder with one electrode 306 disposed on the outer surface of the cylinder and the other electrode 308 disposed on the inner surface of the cylinder. Moreover, in one example, the reference mixture 312 may be present outside the cylinder and the chemical mixture 310 may flow within the cylinder, or vice versa.

Furthermore, greater the difference in oxygen concentration between the reference mixture 312 and the chemical mixture 310, greater the flux and therefore greater the potential difference. The two electrodes 306, 308 may be configured to generate an output voltage corresponding to the quantity of oxygen in the chemical mixture 310 relative to that in the reference mixture 312. For example, an output voltage of 0.2 V DC may represent a “lean mixture” of reductants and oxygen. An output voltage of 0.8 V DC, on the other hand, may represent a “rich mixture,” one which is high in reductants and low in oxygen.

Additionally, the lambda sensor 302 may be a low bandwidth sensor that is configured to determine the concentration of oxygen when the concentration of oxygen is substantially equal to the concentration of the reductants in the mixture 310. An output of the lambda sensor 302 of about 0.5 V DC may be indicative that the concentration of oxygen in the mixture 310 is substantially equal to the concentration of reductants in the mixture 310. At higher or lower oxygen concentrations in the mixture 310, however, the lambda sensor 302 may lose its fidelity. Moreover, as the reducing mixtures in essence are very rich, the output of the lambda sensor 302 may be insufficient to determine the concentration of oxygen in the mixture 310. Accordingly, for lower or higher concentrations of oxygen, the processing unit 208 may be configured to utilize the output from the lambda sensor 302 to determine the type of mixture and estimate a concentration of oxygen in the mixture 310. In case the mixture 310 is lean, the output signal from the lambda sensor 302 may be sufficient to generate the alarm signal 104 indicating that the oxygen levels are excessively high. However, in case the mixture 310 is rich, the embodiments of the present disclosure may utilize the output signal from the second sensing device 206 in addition to the output signal from the lambda sensor 302 to determine the concentration of oxygen in the mixture 310.

In one embodiment, the second sensing device 206 (see FIG. 2) may include an LEL sensor (also known as a combustible gas sensor). LEL sensors are typically utilized as an alarm system to detect trace quantities of flammable gases in a room. To this end, the LEL sensor may be placed in a closed room. Further, the LEL sensor may generate an alarm signal if any flammable gases are leaked into the room and/or if the concentration of the flammable gases in the room exceeds a threshold value. Upon generation of the alarm, corrective or evasive action may be taken. For example, the closed room may be evacuated and/or the source of the leaked gas may be determined and the leak may be subsequently stopped.

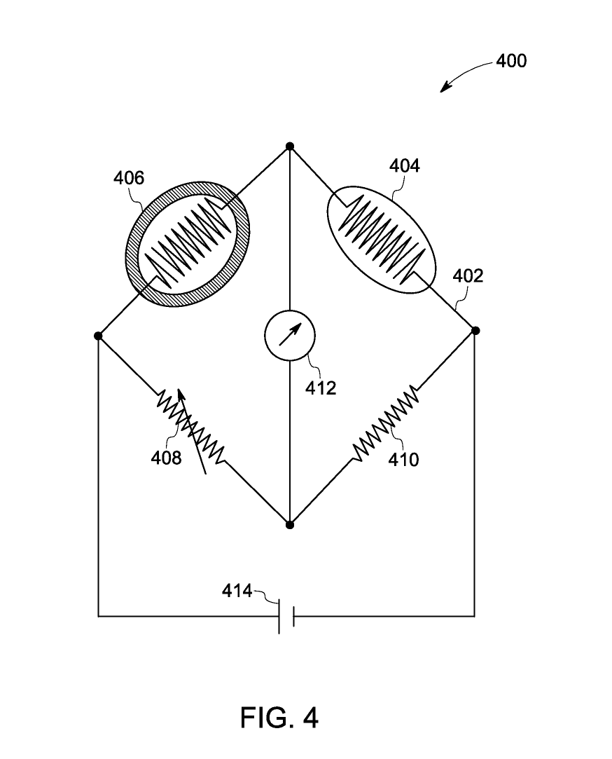

FIG. 4 illustrates an exemplary LEL sensor 400, according to aspects of the present disclosure. In the presently contemplated configuration, the LEL sensor 400 includes a balanced Wheatstone bridge 402. The Wheatstone bridge 402 includes an active coil 404 and a reference coil 406. Moreover, the Wheatstone bridge 402 includes a variable resistor 408 and a fixed resistor 410. The Wheatstone bridge 402 may be balanced by adjusting the value of the variable resistor 408. A voltmeter 412 and a voltage source 414 may be coupled across the two diagonals of the Wheatstone bridge 402.

The active coil 404 and the reference coil 406 may each include at least one bead made of a catalytic material such as platinum. Further, the bead of the reference coil 406 may also be coated with a non-conducting material such as silica. The active coil 404 includes a non-coated bead. Accordingly, the catalytic material of the bead corresponding to the active coil 404 is exposed to the environment. In another embodiment, the beads may be replaced by wires coated with ceramic material. In addition to the ceramic material, the wire of the active coil 404 may be coated with platinum or palladium based materials. In addition, the wire of the reference coil 406 may be coated with the non-conducting ceramic material. When in contact with a mixture, such as the mixture 210 (see FIG. 2), the catalytic coating on the active coil 404, at sufficiently high temperatures, may cause the combustible gases in the mixture 210 to combust.

Accordingly, it may be desirable to increase the temperature of the coils 404, 406, to a desired operating temperature. To that end, an output voltage of the voltage source 414 may be selected to heat the active coil 404 and the reference coil 406 to the desired operating temperature. It will be understood that the temperature of the coils 404, 406 is increased to allow catalytic combustion on the active coil 404 in case a combustible gas is exposed to the active coil 404. Moreover, the desired temperature may depend on the type of gases commonly present in the mixture 210. For instance, if the mixture 210 includes gases with lower catalytic auto-ignition temperature, the beads may be heated to a lower temperature. Alternatively, if the mixture 210 includes gases with higher catalytic auto-ignition temperatures such as carbon monoxide, the beads may be heated to a higher temperature (for example, about 500° C.-600° C.).

In accordance with aspects of the present disclosure, the LEL sensor 400 may be configured to function based on the type of mixture. In case of a rich mixture, an output signal of the LEL sensor 400 may be indicative of the concentration of oxygen in the mixture 210. Also, in the case of a lean mixture, the output signal of the LEL sensor 400 may be indicative of the concentration of reductants in the mixture 210. As rich mixtures generally include large quantities of reductants, but low quantities of oxygen, the amount of the reductants that combusts in contact with the catalytic bead of the active coil 404 may be proportional to the amount of oxygen present in the rich mixture. Presence of oxygen in the rich mixture may aid the reductant in being catalytically combusted on the surface of the active coil 404. This combustion may further increase the temperature of the active coil 404. The temperature of the reference coil 406, however, remains unaffected in the presence of oxygen. The difference between the temperatures of the two coils 404, 406 may produce a change in the electrical resistance of the Wheatstone bridge 402. Accordingly, the electrical resistance of the Wheatstone bridge 402 may be proportional to the amount of oxygen present in the rich mixture.

In case of lean mixtures, the LEL sensor 400 may be configured to measure the amount of reductants present in the chemical mixture 210. Due to high oxygen levels in lean mixtures, the amount of combustion in the LEL sensor 400 may not be indicative of the oxygen content in the lean mixture. Instead, the combustion in the LEL sensor 400 may be indicative of the amount of reductant in the mixture 210. Greater the quantity of reductants in the mixture 210, greater the combustion. This combustion may increase the temperature of the active coil 404. The higher temperature of the active coil 404 may result in a greater difference in resistance between the active coil 404 and the reference coil 406. Therefore, if the mixture 210 is lean, the LEL sensor 400 may be configured to generate an output that is indicative of the concentration of reductants in the mixture 210. And, if the mixture is rich, the LEL sensor 400 may be configured to generate an output that is indicative of the content of oxygen in the mixture 210.

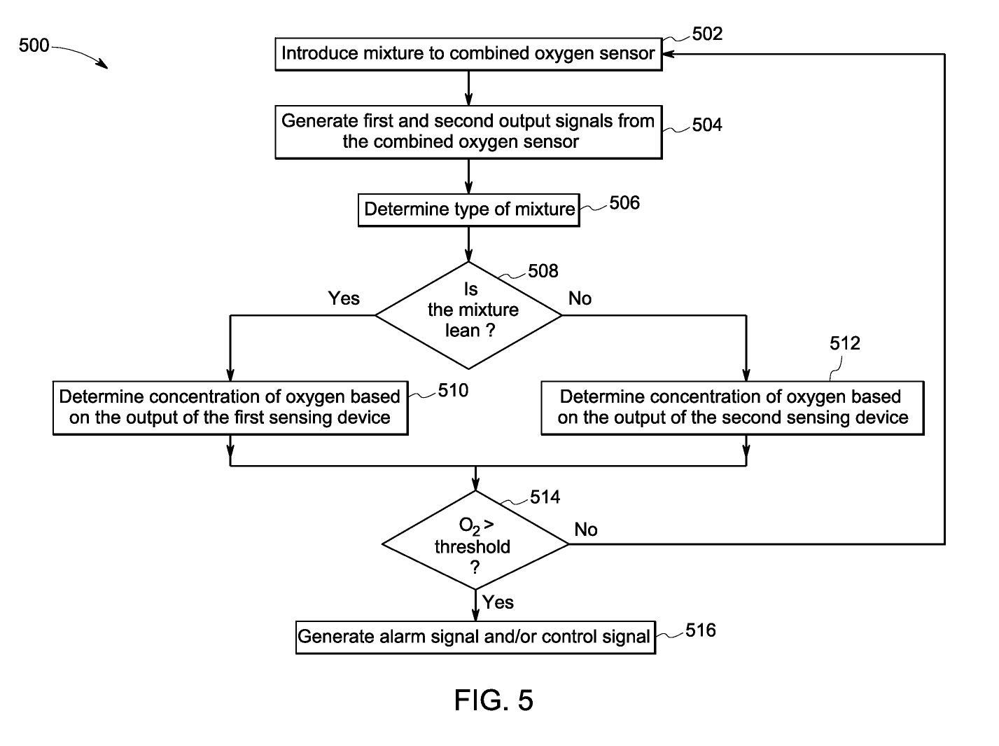

FIG. 5 is a flowchart 500 illustrating an exemplary method for determining a concentration of oxygen in a mixture. The method will be described with reference to FIGS. 1-4. In one embodiment, the mixture, such as the mixture 210 may be a reducing mixture. Alternatively, the mixture 210 may be any other chemical mixture including hydrocarbons, hydrogen, or carbon monoxide without departing from the scope of the present disclosure.

The method begins at step 502, where the mixture 210 is brought in contact with an exemplary oxygen sensor, such as the combined oxygen sensor 102 to determine the concentration of oxygen in the mixture 210. More particularly, the mixture 210 may be brought in contact with first and second sensing devices, such as the first sensing device 204 and the second sensing device 206 of the system 200 (see FIG. 2). As described previously, the sensing devices 202, 204 may be disposed in the flow of the mixture 210 or a portion of the mixture 210 may be redirected such that the mixture 210 is in contact with the sensing devices 202, 204.

Further, at step 504, the first and second sensing devices 204, 206 may be configured to generate first and second output signals, respectively, based on the mixture 210. More particularly, the first sensing device 204 may determine the concentration of oxygen in the mixture by measuring an oxygen flux created between the mixture 210 and a reference mixture, such as ambient air. The second sensing device 206, on the other hand, may determine the concentration of oxygen in the mixture 210 by measuring heat released by an exothermic reaction of the mixture 210 with a catalytic material.

In one embodiment, the first sensing device 204 may be a lambda sensor, such as the lambda sensor 302 and the second sensing device 206 may be a LEL sensor, such as the LEL sensor 400. Accordingly, the first sensing device 204 and the second sensing device 206 may be configured to generate output signals indicative of the concentration of oxygen in the mixture 210. Moreover, the output signal of the first sensing device 204 may be indicative of an estimate of the concentration of oxygen in the mixture 210 and the type of mixture (i.e., lean or rich). Additionally, the output signal of the second sensing device 206 may be indicative of the concentration of oxygen in the mixture 210 or the concentration of reductants in the mixture 210. Furthermore, the output signals from the first sensing device 204 and the second sensing device 206 may be transmitted to the processing unit 208.

Subsequently, at step 506, the processing unit 208 may be configured to determine the type of mixture. In one embodiment, the processing unit 208 may be configured to determine the type of mixture based on the output signal from the first sensing device 204. Moreover, in one example, the processing unit 208 may include a lookup table or a comparator to determine the type of mixture. For instance, the output signal from the first sensing device 204 may be compared with values stored in the lookup table or with a threshold value in the comparator. Based on the lookup table or the comparator output, the processing unit 208 may be configured to determine whether the mixture is a lean mixture or a rich mixture.

Furthermore, at step 508, a check may be carried out to determine whether the type of mixture is lean. At step 508, if it is determined that the mixture 210 is lean, the processing unit 208 may be configured to determine the concentration of oxygen based on the output signal from the first sensing device 204, as indicated by step 510. In one embodiment, the processing unit 208 may be configured to compare the output signal with oxygen concentration values in a lookup table.

Alternatively, at step 508, if it is determined that the mixture 210 is rich, the concentration of oxygen in the mixture 210 may be determined based on the output signal of the second sensing device 206, as indicated by step 512. More particularly, the processing unit 208 may be configured to determine the concentration of oxygen in the mixture by utilizing a lookup table to compare the output signal from the second sensing device 206 with voltage signal values stored in the lookup table.

Subsequently, the processing unit 208 may be configured to compare the concentration of oxygen in the mixture 210 determined at the output of steps 510 and 512 with a determined threshold value, as indicated by step 514. If the concentration of oxygen is higher than the threshold value, the processing unit 208 may be configured to generate a control signal 106, an alarm signal 104, or a combination thereof, as indicated by step 516. Moreover, if the processing unit 208 generates the alarm signal 104, an operator may be warned and the operator may take desired corrective actions. Alternatively, if the processing unit 208 generates the control signal 106, the control signal 106 may be communicated to the controller 108. The controller 108 may be configured to alter process parameters, vary concentration of different components of the mixture 210, or take any other such steps to reduce the concentration of oxygen below the threshold value.

However, at step 516, if it is determined that the concentration of oxygen is lower than the threshold value, the processing unit 208 may be configured to continue to measure the concentration of oxygen in the mixture 210. It will be understood that this method may continue in a loop as long as the chemical plant, the turbine, or any other such plant is operational. Moreover, the combined oxygen sensor 102 may be configured to determine the concentration of oxygen at determined intervals of time or continuously without departing from the scope of the present disclosure.

The exemplary combined oxygen sensor and the method for determining the concentration of oxygen in a mixture described hereinabove may be employed to determine the concentration of oxygen in chemical mixtures. More particularly, the combined oxygen sensor may be used to determine the concentration of oxygen in reducing mixtures. Based on the determination, the combined oxygen sensor may be configured to generate an alarm signal and/or a control signal to alert an operator/plant or alter conditions of the chemical process. The exemplary combined oxygen sensor of the present disclosure may aid in the determination of the concentration of oxygen in rich mixtures with enhanced accuracy.

Furthermore, a skilled artisan will recognize the interchangeability of various features from different embodiments. Similarly, the various method steps and features described, as well as other known equivalents for each such methods and feature, can be mixed and matched by one of ordinary skill in this art to construct additional assemblies and techniques in accordance with principles of this disclosure.

In addition, the foregoing examples, demonstrations, and process steps such as those that may be performed by the system may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, including but not limited to C++ or Java. Such code may be stored or adapted for storage on one or more tangible, machine-readable media, such as on data repository chips, local or remote hard disks, optical disks (that is, CDs or DVDs), memory, or other media, which may be accessed by a processor-based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a data repository or memory.

Moreover, the various lookup tables of the processing unit may be incorporated in any data repository system. For example, these lookup tables may be implemented in a read only memory, random access memory, flash memory, relational databases, or any other form of memory without departing from the scope of the present disclosure. Further, these lookup tables may be stored in a single data repository or in individual data repositories.

While only certain features of the invention have been illustrated and described herein, many modifications and changes may occur to those skilled in the art. It is, therefore, to be understood that the appended claims are intended to cover all such modifications and changes as fall within the true spirit of the disclosure.

1. A system for determining concentration of oxygen in a chemical mixture, the system comprising:
a first sensing device configured to measure the concentration of oxygen in the chemical mixture and generate a first output signal, wherein the first output signal is indicative of the concentration of oxygen in the chemical mixture and a type of the chemical mixture;
a second sensing device configured to measure the concentration of oxygen in the chemical mixture and generate a second output signal;
a processing unit operatively coupled to the first sensing device and the second sensing device and configured to determine the concentration of oxygen in the chemical mixture using the first output signal, the second output signal, or both the first output signal and the second output signal based on the type of the chemical mixture.

2. The system of claim 1, wherein the first sensing device is configured to determine whether the type of the chemical mixture is a lean mixture or a rich mixture.

3. The system of claim 2, wherein the processing unit is configured to determine the concentration of oxygen in the chemical mixture based on the first output signal if the mixture is the lean mixture.

4. The system of claim 2, wherein the processing unit is configured to determine the concentration of oxygen in the chemical mixture based on the second output signal if the mixture is the rich mixture.

5. The system of claim 1, wherein the processing unit is configured to generate an alarm signal, a control signal, or both the alarm signal and the control signal based on the determined concentration of oxygen.

6. The system of claim 5, further comprising a controller configured to alter the concentration of oxygen in the mixture based on the control signal.

7. The system of claim 1, wherein the first sensing device is a lambda sensor.

8. The system of claim 1, wherein the second sensing device is a lower explosion limit sensor.

9. The system of claim 1, wherein the chemical mixture is a reducing mixture.

10. A method for determining concentration of oxygen in a chemical mixture, the method comprising:
measuring the concentration of oxygen in the chemical mixture using a first sensing device;
generating a first output signal based on the measurement by the first sensing device, wherein the first output signal is indicative of the concentration of oxygen in the mixture and a type of the chemical mixture;
measuring the concentration of oxygen in the chemical mixture using a second sensing device;
generating a second output signal based on the measurement by the second sensing device; and
determining the concentration of oxygen in the chemical mixture using the first output signal, the second output signal, or both the first output signal and the second output signal based on the type of the chemical mixture.

11. The method of claim 10, wherein measuring the concentration of oxygen in the mixture using the first sensing device comprises determining whether the chemical mixture is a lean mixture or a rich mixture.

12. The method of claim 11, wherein determining the concentration of oxygen in the mixture comprises determining the concentration of oxygen in the chemical mixture based on the first output signal if the chemical mixture is the lean mixture.

13. The method of claim 11, wherein determining the concentration of oxygen in the mixture comprises determining the concentration of oxygen in the chemical mixture based on the second output signal if the chemical mixture is the rich mixture.

14. The method of claim 10, further comprising generating an alarm signal, a control signal, or both the alarm signal and the control signal if the determined concentration of oxygen is above a determined threshold value.

15. The method of claim 14, further comprising transmitting the control signal to a controller for altering the concentration of oxygen in the chemical mixture.

16. The method of claim 10, wherein measuring the concentration of oxygen using the first sensing device comprises measuring an oxygen flux between a reference mixture and the chemical mixture.

17. The method of claim 10, wherein measuring the concentration of oxygen using the second sensing device comprises measuring heat released by an exothermic reaction of the chemical mixture with the second sensing device.

18. A system for determining concentration of oxygen in a reducing mixture, the system comprising:
a combined oxygen sensor comprising:
a lambda sensor configured to:
measure the concentration of oxygen in the reducing mixture;
generate a first output signal indicative of a type of the reducing mixture, wherein the type of the reducing mixture comprises a rich mixture or a lean mixture;
a lower explosion limit sensor configured to:
measure the concentration of oxygen in the reducing mixture;
generate a second output signal, wherein the second output signal is indicative of the concentration of oxygen in the rich mixture and indicative of the concentration of reductants in the lean mixture; and
a processing unit coupled to the lambda sensor and the lower explosion limit sensor and configured to utilize the first output signal if the mixture is the lean mixture and the second output signal if the mixture is the rich mixture.

19. The system of claim 18, wherein the processing unit is further configured to generate an alarm signal, a control signal, or both the alarm signal and the control signal if the determined concentration of oxygen is above a determined threshold value.

20. The system of claim 19, further comprising a controller configured to reduce the concentration of oxygen in the mixture below the determined threshold value based on the control signal.
